(19) United States
(12) Patent Application Publication
(10) Pub. No.: US 2002/0154216 A1
(43) Pub. Date: Oct. 24, 2002

(54) Method and apparatus for microscopic observation

(76) Inventor: Kanji Yahiro, Fukuoka (JP)

Correspondence Address: MCDERMOTT WILL & EMERY, 600 13TH STREET, N.W., WASHINGTON, DC, 20005-3096, US

(21) Appl. No.: 10/114,328

(22) Filed: Apr. 3, 2002

(30) Foreign Application Priority Data
Apr. 5, 2001 (JP) 2001-106760

(51) Int. Cl. H04N 7/18

(52) U.S. Cl. 348/79

(57) ABSTRACT

A microscopic observation apparatus captures a microscopic image of a specimen stored in a container. Each well in the container is positioned in an image-shooting position of a camera by controlling a table transfer unit for moving a specimen table holding the container based on central point coordinates of each well whose origin is reference point R defined for the container and relative coordinates of an observation point in the well whose origin is this central point coordinates. This enables the efficient capturing of microscopic images of the specimens.

### FIELD OF THE INVENTION

The present invention relates to a method and apparatus for microscopic observation to capture microscopic images of biological specimens such as animal and plant cells.

### BACKGROUND OF THE INVENTION

Tests in the biochemical field very often involve microscopic observations to capture microscopic images of biological specimens such as animal and plant cells and microorganisms, as well as observation of biological specimens using a microscope. The specimen to be observed is usually placed in a container such as a microplate. The following method is generally applied to capture the microscopic image of the specimen placed in the microplate: the microplate is set on the specimen table of the microscope. While moving the specimen manually, the target section to be observed is positioned in the field of view of the microscope to enable capture of the image.

In general, however, numerous specimens need to be observed. Microscopic observation using the conventional method as described above requires time-consuming handling, significantly reducing the efficiency of the whole experimental operation. The operator in charge of the experiment also bears a significant burden.

### SUMMARY OF THE INVENTION

The present invention addresses the above disadvantage, and aims to offer a method and apparatus for microscopic observation enabling the efficient capturing of microscopic images of specimens.

The microscopic observation apparatus of the present invention captures the microscopic images of specimens placed in two or more specimen-disposing-sections in a container, and includes:

(a) a holder for holding the container;

(b) a camera for capturing the microscopic images of the specimens;

(c) a transfer unit for moving the container held with the holder relative to the camera; and

(d) an observation point controller.

The observation point controller positions each specimen-disposing-section in the image-shooting position of the camera by controlling the transfer unit based on first coordinates (coordinates for indicating a position) of each specimen-disposing-section whose origin is a reference point defined for the container and relative coordinates of the observation point whose origin is the first coordinates.

The microscopic observation method of the present invention is for capturing the microscopic images of the specimens placed in two or more specimen-disposing-sections in the container, and includes the steps of:

(a) holding the container with the holder;

(b) moving the container held with the holder relative to the camera; and

(c) positioning each specimen-disposing-section in the image-shooting position of the camera by controlling the transfer unit based on point coordinates of each specimen-disposing-section whose origin is the reference point defined for the container and the relative coordinates of the observation point whose origin is this point coordinates.

The above structure and method of the present invention enables the efficient capturing of microscopic images of specimens.

### BRIEF DESCRIPTION OF THE DRAWINGS

FIG. 1 is a perspective view of a microscopic observation apparatus in accordance with a preferred embodiment of the present invention.

FIG. 2 is a block diagram of a configuration of a microscopic observation apparatus in accordance with the preferred embodiment of the present invention.

FIG. 3 is a block diagram of a positioning function of the microscopic observation apparatus in accordance with the preferred embodiment of the present invention.

FIG. 4A is an explanatory chart illustrating microplate information of the microscopic observation apparatus in accordance with the preferred embodiment of the present invention.

FIG. 4B is an explanatory chart illustrating observation point information of the microscopic observation apparatus in accordance with the preferred embodiment of the present invention.

FIG. 5 is a display screen of the microscopic observation apparatus in accordance with the preferred embodiment of the present invention.

FIG. 6 is a flow chart of a basic operation program for a microscopic observation method in accordance with the preferred embodiment of the present invention.

FIG. 7 is a flow chart of an auto-observation program of the microscopic observation method in accordance with the preferred embodiment of the present invention.

FIGS. 8A and 8B are plan views of a specimen table of the microscopic observation apparatus in accordance with the preferred embodiment of the present invention.

### DETAILED DESCRIPTION OF PREFERRED EMBODIMENT

A preferred embodiment of the present invention is described with reference to drawings.

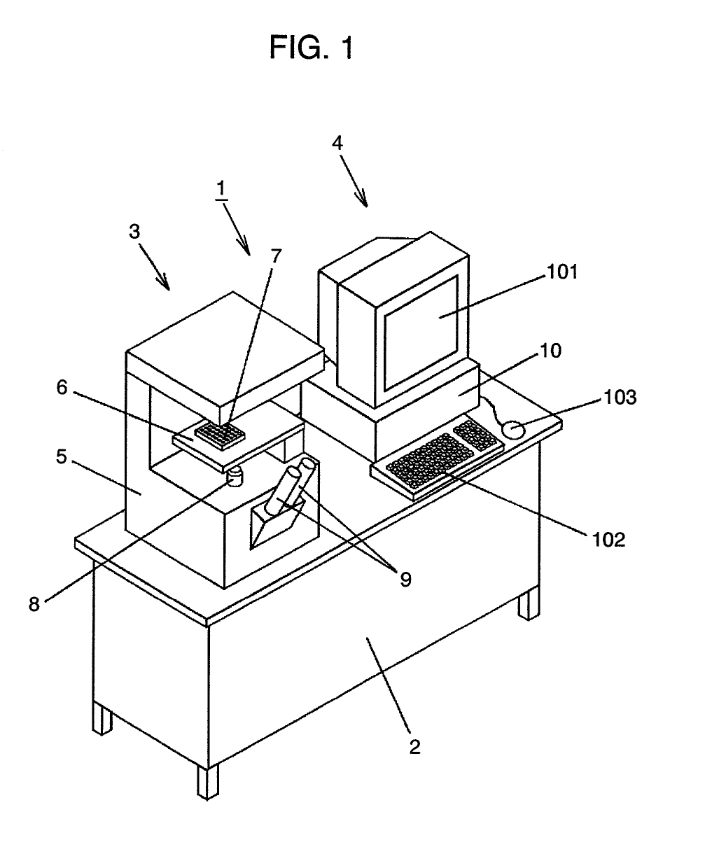

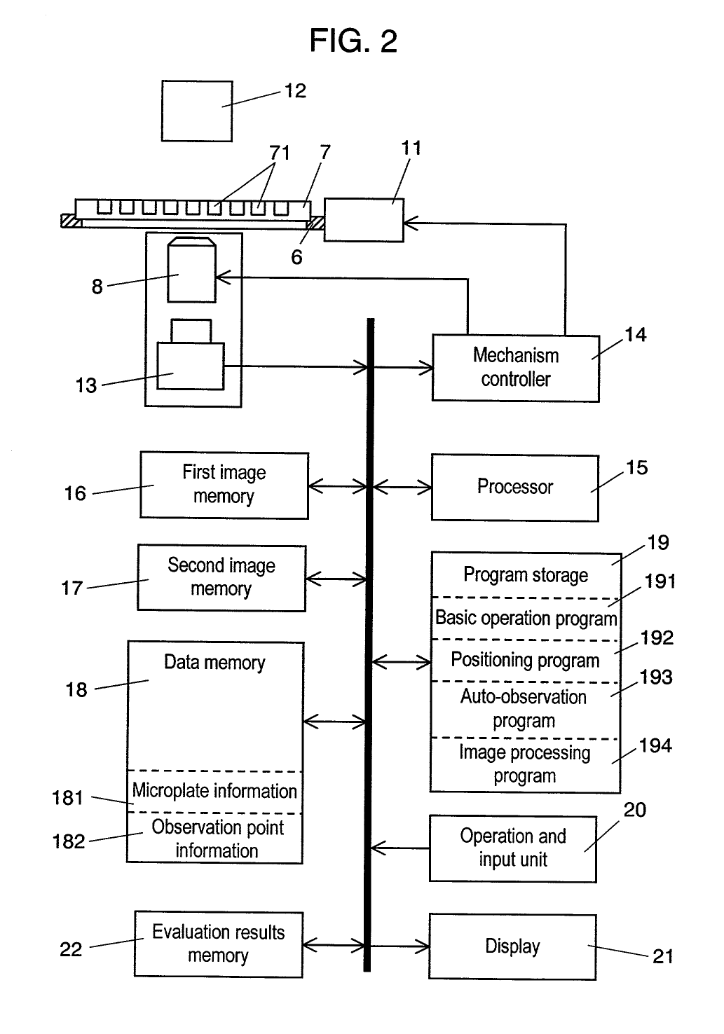

FIG. 1 is a perspective view of a microscopic observation apparatus in the preferred embodiment of the present invention. FIG. 2 is a block diagram of the configuration of the microscopic observation apparatus.

In FIG. 1, microscopic observation apparatus 1 is configured by disposing microscopic observation unit 3 and control unit 4 in parallel on stand 2. Microscopic observation unit 3 is equipped with a camera (described later) incorporated inside frame 5 and specimen table 6 for holding micro plate 7 which is a specimen container. The camera takes the microscopic image of a specimen such as biological specimen including cells of animals and plants placed on microplate 7 through optical system 8. Microscopic observation unit 3 has eyepiece lens 9. The biological specimen on microplate 7 may be observed by eye through this eyepiece lens 9. Specimen table 6 is a holder for holding microplate 7.

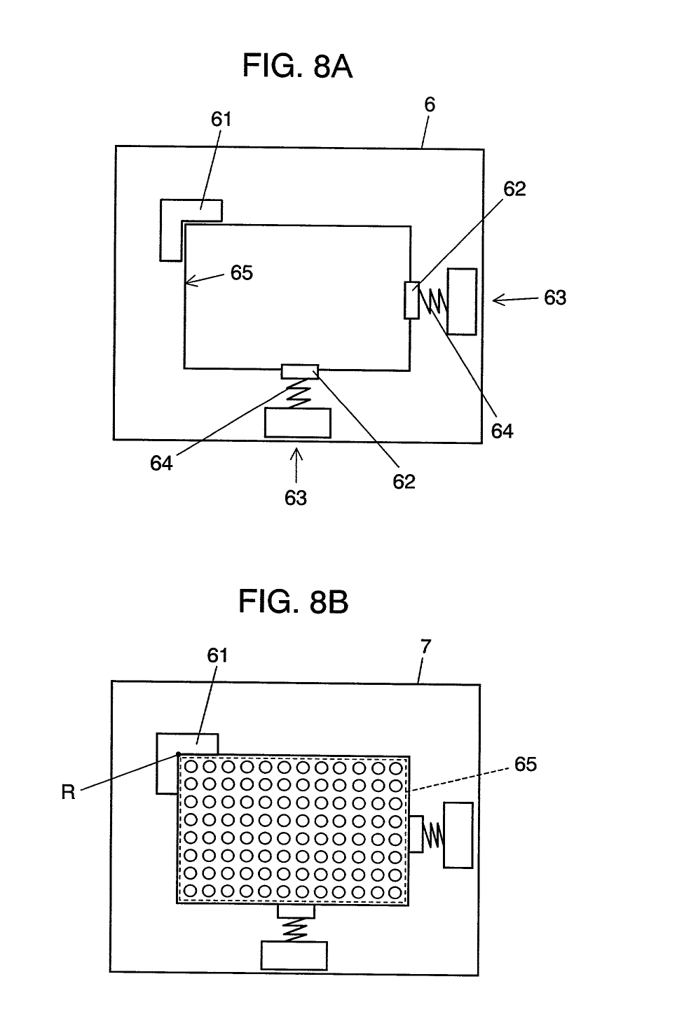

Specimen table 6 is further described next. FIG. 8A is a plan view of the specimen table of the microscopic observation apparatus in the preferred embodiment of the present invention.

In FIG. 8A, positioner 61 is attached at a predetermined position on specimen table 6. Positioner 61 contacts at least two perpendicular side faces of microplate 7. As shown in FIG. 8A, positioner 61 is an L-shaped block. Positioner 61 may also be configured with several pins or concave and convex processes on specimen table 6. Specimen table 6 has two clamp mechanisms 63 attached to it, and these clamp mechanisms 63 have pushing member 62 that is slidably supported back and forth by respective spring members 64. Specimen table 6 also has opening 65 at the center. Through this opening 65, the camera takes an image of the specimen.

FIG. 8B is a plan view of specimen table 6 holding microplate 7. Microplate 7 is disposed over opening 65, and side faces of microplate 7 are clamped and held with two pushing members 62 and positioner 61. Microplate 7 is secured in a way that its reference point R matches the position specified by positioner 61, which is the position registered in advance on the coordinate system of table transfer unit 11 shown in FIG. 2.

When a command based on coordinates (coordinates for indicating a position) of table transfer unit 11 is output, a required point in microplate 7 may be moved over the image-shooting position of camera 13. Positioner 61 and clamping mechanism 63 configure positioning means for positioning microplate 7 to a predetermined position on specimen table 6 (the position specified by positioner 61, which is the position registered on the coordinate system of table transfer unit 11).

In FIG. 1, personal computer 10 is disposed in control unit 4, and the image taken by microscopic observation unit 3 may be displayed on monitor 101. Keyboard 102 and mouse 103 are used for inputting a range of data and operation commands by displaying input screen or operation screen on monitor 101.

Next, the configuration of the microscopic observation unit and control system is described with reference to FIG. 2. In FIG. 2, many wells 71 (specimen-disposing-sections) which store specimen are provided in a matrix on microplate 7, and this microplate 7 is held with specimen table 6. Specimen table 6 moves horizontally in the XY direction driven by table transfer unit 11. Optical system 8 and camera 13 are disposed under specimen table 6. Camera 13 takes the image of the specimen in well 71 illuminated by lighting unit 12 disposed over specimen table 6. In other words, camera 13 is an image-shooting unit for capturing microscopic images of the specimen in the container. Mechanism controller 14 controls optical system 8 and table transfer unit 11. Table transfer unit 11 is a transport unit for moving microplate 7 secured on specimen table 6 relative to camera 13.

Processor 15 is a CPU, and various calculations and processing are conducted by executing programs stored in program storage 19 based on data stored in data memory 18. First image memory 16 stores image data captured by camera 13. Second image memory 17 stores processed images after processing image data read out from first image memory 16.

Data memory 18 stores microplate information 181 and observation point information 182. Microplate information 181 covers alignment and position of wells 71 in microplate 7 to be observed.

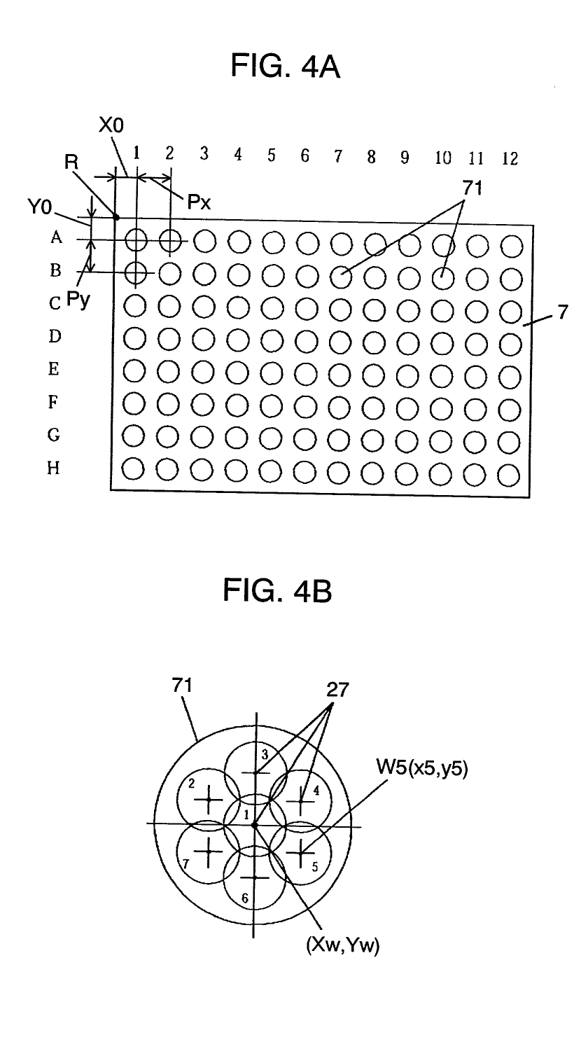

FIG. 4A is an explanatory chart illustrating microplate information of the microscopic observation apparatus in the preferred embodiment of the present invention. FIG. 4B is an explanatory chart illustrating observation point information of the microscopic observation apparatus in the preferred embodiment of the present invention.

Microplate information is detailed next. As shown in FIG. 4A, wells 71 are aligned on grids of A to H rows and 1 to 12 columns on microplate 7. A well address created by combining the row number and column number is designated to each well 71. Microplate information 181 includes the row number and column number of each well 71, alignment pitch Pₓ, P_{y} between wells, and coordinates (X0, Y0) for identifying the positional relationship between reference point R given to one corner point and the nearest well 71(hereafter referred to as reference well coordinates).

Based on this microplate information 181 and well address, coordinates of a particular well 71 are calculated and identified. More specifically, the first coordinates (central coordinates (X_{w}, Y_{w}) of well 71 in FIG. 4B) referring to reference point R of particular well 71 is obtained by using the well address of the particular well, reference well coordinates (X0, Y0), and alignment pitch Pₓ, P_{y}.

The coordinates of reference point R on specimen table 6, in which the microplate 7 is placed, are already identified with respect to the coordinate system of table transfer unit 11. Accordingly, the coordinates of predetermined well 71 in the coordinate system of table transfer unit 11 may be calculated by designating the well address of the predetermined well to be observed in many wells. Based on these calculated coordinates, table transfer unit 11 moves microplate 7 to position the particular well 71 in the image-shooting position of camera 13. Microplate information 181 does not necessarily require reference well coordinates (X₀, Y₀), row and column numbers of well 71, and alignment pitch Px, Py, as described above, as long as well address information covers information for identifying the coordinates of the particular well 71 from reference point R.

Next, observation point information is described. Observation point information 182 is the observation point in each well 71, i.e., information which indicates the target point to be moved relative to the image-shooting position of camera 13. When microscopic image-shooting is conducted through optical system 8, the image-shooting area of camera 13 is smaller than the size of each well 71, and thus the entire area in well 71 cannot be covered by one shot. Accordingly, as shown in FIG. 4B, images of the same well 71 are captured several times to cover one well 71. For this purpose, two or more observation points 27 which are target points to be moved to the image-shooting position are set. Here, the Figure illustrates the case where six observation points (observation point Nos. 2-7) are set to equal 60-degree positions around one observation point (observation point No. 1) designated in the center of well 71.

Coordinates indicating individual observation points are set as relative coordinates to the well involved. In other words, coordinates indicating individual observation points are set as the coordinates taking the center point of each well 71 (center coordinates (X_{w}, Y_{w}) of well 71) as its origin (hereafter referred to as “relative coordinates of the observation point”). For example, as shown in FIG. 4B, relative coordinates W5 (x5, y5) are set relative to the origin, which are the central coordinates (X_{w}, Y_{w}) of well 71, as the relative coordinates of the observation point No. 5. In other words, the relative coordinates of the observation point involved referring to the central point of the well involved are identifiable based on observation point information by designating the observation point number of a specific observation point. As a result, the second coordinates of the observation point whose origin is reference point R are obtainable, based on the first coordinates of each well whose origin is reference point R defined for microplate 7 and the relative coordinates of each observation point whose origin is this first coordinates.

The image-shooting position (image-shooting field) of camera 13 is relatively moved to the specific observation point 27 in specific well 71 on microplate 7 based on microplate information 181 and observation point information 182 by designating the well address as described above and the observation point number. This allows to obtain a microscopic image of the specimen by camera 13 while having the specimen in the center of the image-shooting field.

Program storage 19 stores basic operation program 191, positioning program 192, auto-observation program 193, and image processing program 194. Basic operation program 191 is a processing program for basic operation of microscopic observation apparatus 1. According to the basic operation, a move command for identifying the observation point in microplate 7 is output. Positioning program 192 is for positioning the observation point of microplate 7 to the image-shooting position of camera 9 based on the move command. Processor 15 executes these programs.

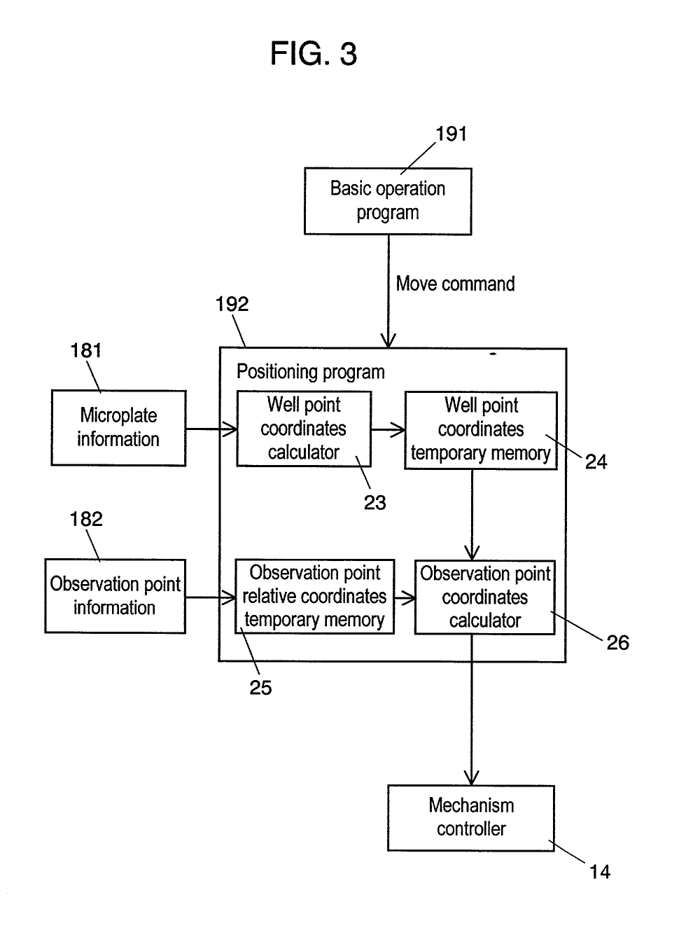

FIG. 3 is a block diagram illustrating a positioning function of the microscopic observation apparatus in the preferred embodiment of the present invention. Positioning conducted by positioning program 192 is described next with reference to FIG. 3.

The move command is output to designate the well address to be observed or the observation point number indicating the observation point by executing basic operation program 191. When the well address is input as the move command, well position coordinates calculator 23, part of positioning program 192, calculates the well coordinates designated by the well address, and these well coordinates are stored in well coordinates temporary memory 24. When the observation point number is input as the move command, the relative coordinates of the observation point designated by the observation point number are read out from observation point information 182, and are stored in observation point relative coordinates temporary memory 25.

Observation point coordinates calculator 26 reads the well coordinates in memory 24 and relative coordinates of the observation point in memory 25. These sets of coordinates are added to calculate coordinates for moving the observation point involved to the image-shooting position of camera 13, i.e., the second coordinates of the observation point whose origin is reference point R (hereafter referred to as “observation point coordinates”).

These observation point coordinates are output to mechanism controller 14, and mechanism controller 14 controls table transfer unit 11 according to the observation point coordinates. Microplate 7 on specimen table 6 then moves so that the required observation point moves to the image-shooting position of camera 13.

As described above, processor 15 calculates the observation point coordinates by executing positioning program 192. Mechanism controller 14 controls table transfer unit 11 based on calculated observation point coordinates. In other words, table transfer unit 11 is controlled by program storage 19, processor 15, and mechanism controller 14 based on the well point coordinates and relative coordinates of the observation point. This configures an observation point controller for positioning observation target point on microplate 7 in the image-shooting position of camera 13.

Auto-observation program 193 is for observing the observation points set in the well automatically according to a predetermined order and a predetermined procedure. By executing this program 193, consecutive microscopic observation is feasible by selecting buttons on the operation screen as described later for automatically moving each observation point of many wells 71 to the image-shooting position of camera 13.

Image processing program 194 is a program for processing image data stored in first image memory 16 which is taken by camera 13.

Operation and input unit 20 is keyboard 102 or mouse 103 of personal computer 10, and are used for inputting to the control panel. Display 21 is monitor 101 of personal computer 10, which displays images captured and operation screens. Evaluation results memory 22 stores evaluation results such as numeric data obtained through image processing.

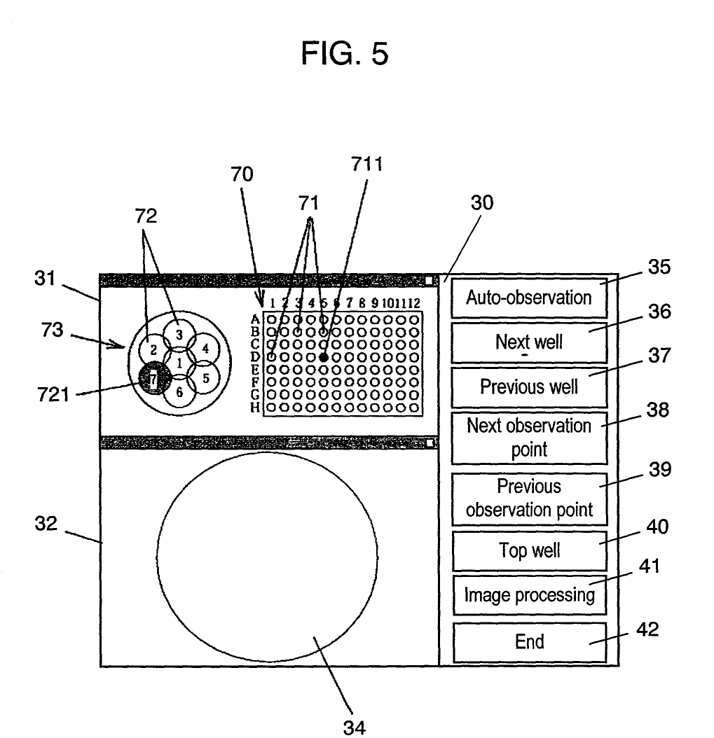

FIG. 5 shows the display screen of the microscopic observation apparatus in the preferred embodiment of the present invention. With reference to FIG. 5, operation screens displayed on monitor 101 in FIG. 1 are described next. In FIG. 5, screen 30 displays observation point display window 31 for displaying observation points and shooting image display window 32. Window 31 displays graphic image 70 showing microplate 7 in FIG. 4A, graphic image 71 showing well 71 in FIG. 4B, and graphic image 73 showing observation point 27 in well 71. Graphic image 711 corresponding to the well to be observed (well address D-5 in this case) and graphic image 721 corresponding to the observation point to be observed (observation point No. 7 in this case) are highlighted on the screen. This enables to understand at a glance that well 711 which is being currently observed and the current observation point in the current well 71, i.e., the target observation point, on screen 30. Accordingly, display 21 (monitor 101) visually displays the position of the observation point (the observation point to be observed) in the image-shooting position using graphic images.

Window 31 also functions as an operation panel for outputting move commands. Each of the graphic images 71 and 72 on the display screen is an operation button for inputting the move command. In other words, keyboard 102 and mouse 103 are operated to overlay a pointer on the screen on graphic image 711 or 721 corresponding to required well 71 or observation point 27 and clicked to output the corresponding well address and observation point number to positioning program 192. By executing positioning program 192, observation point 27 in well 71 designated by clicking is moved to the image-shooting position of camera 13. Operation and input unit 20 (keyboard 102 and mouse 103) is thus an input unit for instructing and inputting the observation point by the camera using displayed graphic images.

Shooting image display window 32 displays image 34 currently being taken and its processed image. Operation buttons are displayed to the right of screen 30. By pushing auto-observation button 35, the biological specimen in microplate 7 is automatically observed. In other words, the move command is automatically output to the positioning program according to a predetermined procedure. The observation point sequentially moves to the image-shooting position of camera 13 in response to this move command. An image of the observation point of the specimen is then taken and the image data obtained is processed automatically every time the observation point moves.

Operation buttons 36 to 40 are move command input buttons, and predetermined well 71 or observation point 27 moves to the image-shooting position of camera 13 by operating these buttons. Operation buttons 36 and 37 are operation buttons for outputting move commands for well 71. By operating these buttons, well address of next well of the current well 71 and well address of previous well of the current well 71 are output to the positioning program. In line with this operation, highlighted well 71 on observation point display window 31 moves forward or backward by one well. Operation buttons 38 and 39 are move commands for observation points in each individual well 71. By operating these buttons, observation point numbers of the current observation point, next observation point, and previous observation point are output to positioning program 192. In line with this operation, the highlighted observation point 27 on observation point display window 31 advances or retreats by one point.

By operating operation button 40, well 71 at the top of microplate 7, i.e., the well address of well 71 and the observation point number of observation point 27 for a portion to be observed first in the auto-observation, is output. By operating image processing button 41, image processing of an obtained and temporarily stored image is executed. Operating end button 42 completes microscopic observation. By operating operation buttons 36 to 41 as described above, a predetermined observation point in a predetermined well may be observed semi-automatically.

The preferred embodiment of the present invention employs microplate 7 in which many wells 71 are aligned in matrix format. It is apparent, however, the present invention is not limited to matrix alignment. The container may naturally have different styles. For example, a dish container or a simple glass sheet is applicable, provided that the specimens are stored or placed at predetermined points, data on these predetermined points is created as point information on a specimen-disposing-section, and observation points are set by relative coordinates to the specimen-disposing-section.

As described above, the microscopic observation apparatus of the present invention enables the efficient capture of microscopic images of specimens while taking microscopic images of specimens in the container by the camera. Each specimen-disposing-section is positioned in the image-shooting position of the camera by controlling the transfer unit that holds and moves the container based on the first coordinates of each specimen-disposing-section whose origin is a reference point defined for the container and relative coordinates of the observation point whose origin is the first coordinates.

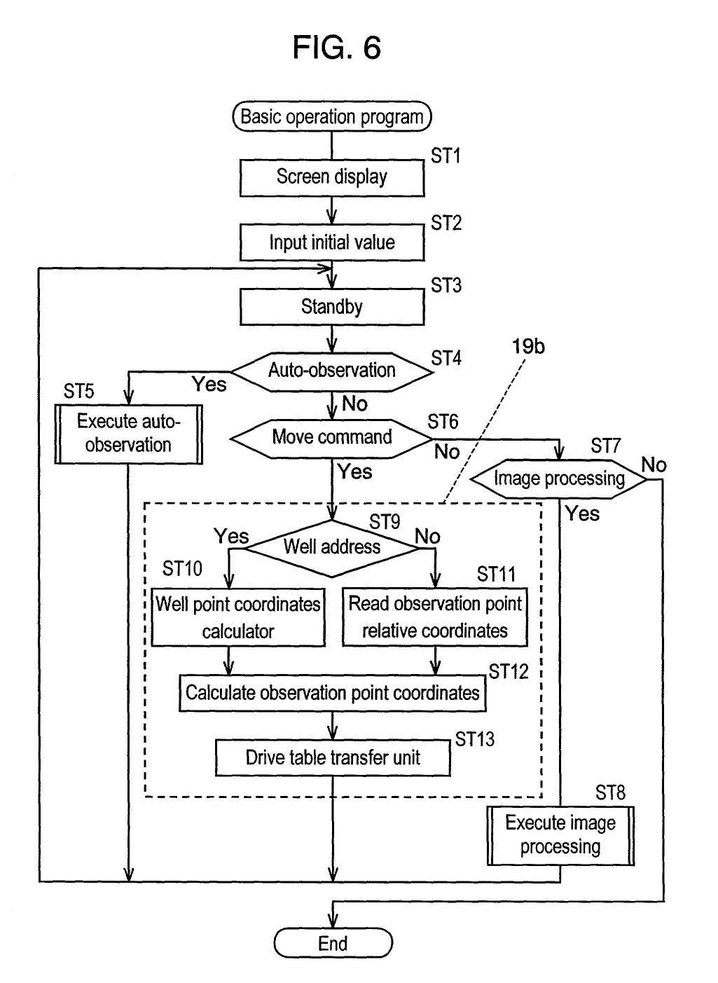

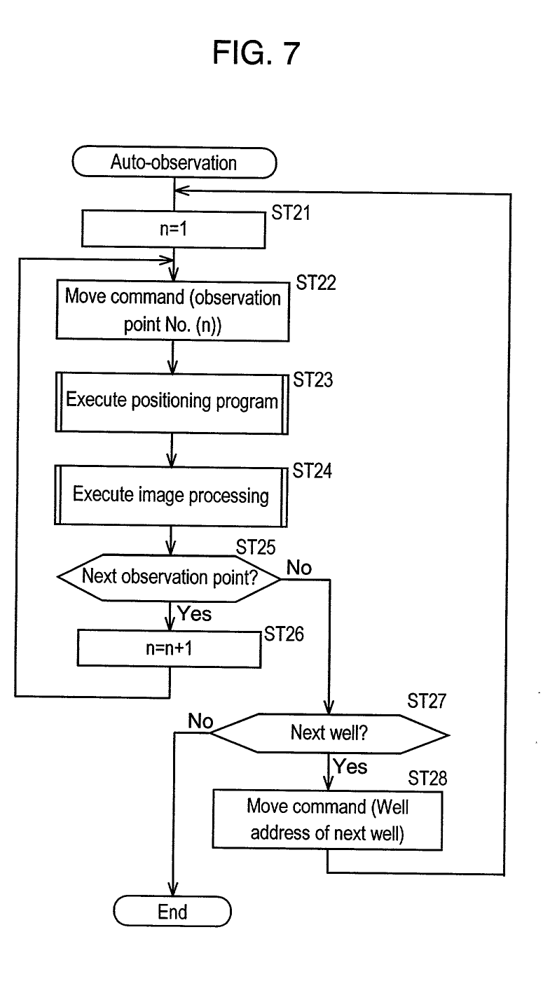

Next, a microscopic observation method of the present invention is described with reference to FIGS. 6 and 7.

FIG. 6 is a processing flow chart of the basic operation program in the microscopic observation method in the preferred embodiment of the present invention. FIG. 7 is a processing flow chart of the auto-observation program in the microscopic observation method.

First, processing performed by executing the basic operation program is described with reference to the flow illustrated in FIG. 6. First, in FIG. 6, turn on the apparatus to display an operation screen shown in FIG. 5 on monitor 101 as shown in FIG. 1 (ST1). Then, input an initial value indicating the initial observation point on the screen (ST2). In other words, input well address A-1 and observation point No. 1 to positioning program 192 to place the observation point identified by well address A-1 and observation point No. 1 to the image-shooting position. This allows the selection of auto-observation of each well 71 in the predetermined sequence, and the apparatus enters the input standby mode in this state (ST3).

If something is input in this state, the apparatus determines whether the auto-observation button (auto-observation button 35 in FIG. 5) has been selected or not (ST4). Here, auto-observation is executed when the applicable button is operated (ST5). The apparatus then returns to the input standby mode. If auto-observation is not selected, the apparatus determines whether the move command is output by operating one of operation buttons 36 to 40, 71, or 72 in FIG. 5 (ST6). If the move command is not output, the apparatus determines whether image processing button 41 has been operated. If it has, image processing is executed (ST 8), and the apparatus then returns to the input standby mode (ST7). If image processing button 41 is not pressed, the apparatus determines that end button 42 has been pressed, and ends processing.

In (ST6), if the move command is output, positioning program 192 (ST9 to ST13) is executed. The program 192 first determines whether the move command is the well address or observation point number (ST9). If the move command is the well address, the well point coordinates calculator 23 shown in FIG. 3 calculates the well point coordinates (ST10). If the move command is the observation point number, the relative coordinates of the observation point readout based on this observation point number are stored in observation point relative coordinates temporary memory 25 (ST11). Based on the well point coordinates and relative coordinates of the observation point, observation point coordinates calculator 26 calculates the observation point coordinates (ST12). By outputting these observation point coordinates to mechanism controller 14, table transfer unit 11 is driven. This moves the designated observation point in the designated well to the image-shooting position of camera 13, after which the apparatus returns to the input standby mode (ST3).

Next, the processing flow for executing auto-observation shown in (ST5) in the above flow is detailed with reference to FIG. 7. Here, observation points in the well identified by the well address already output in the step previous to (ST5) in the above flow are sequentially moved to the image-shooting position of camera 13 for auto-observation.

First, set observation point No. (n) to 1 for initialization (ST21). Then, output the move command for a target observation point No (n) (ST22). The positioning program is then executed in the same way as (ST9) to (ST13) shown in FIG. 6 (ST 23). Then, the apparatus executes image processing of the image taken by moving observation point 27 to the image-shooting position by positioning (ST24). Evaluation results memory 22 stores image processing results.

The apparatus next determines whether next observation point 27 to be observed exists in the same well 71 (ST25). If there is another observation point 27, count No. (n) of the observation point number is replaced to (n+1) (ST26). The program then returns to (ST22) to repeat the observation operation. If there is no more observation point 27 in (ST25), the program checks the presence of next well 71 to be observed (ST27). If next well 71 exists, the well address of the next well 71 is output as the move command (ST28). Then, the program returns to (ST21) to repeat the observation operation. When there are no more wells 71 in (ST27), the program determines that the entire observation is complete, and auto-operation ends. In auto-observation, not all observation points 27 in all wells 71 may be set as observation targets. Only particular wells in microplate 7 or only particular observation points 27 in well 71 may be set as observation targets.

In the microscopic observation method of the present invention as described above, information for identifying observation points of specimens stored in the specimen-disposing-section in the container is set as the first point coordinates of the specimen-disposing-section whose origin is a reference point defined in terms of the container. In addition, the relative coordinates of the observation point whose origin is this first coordinates of the specimen-disposing-section are set in advance. The observation point coordinates (second coordinates) whose origin is a reference point of the observation point are then determined based on the first coordinates and relative coordinates. The transfer unit for moving the container relative to the camera is controlled based on the observation point coordinates obtained when the camera takes a microscopic image of the specimen to be observed. A particular observation point which is a target observation point is thus positioned in the image-shooting position of the camera.

Accordingly, the microscopic observation method of the present invention enables the easy and efficient capture of microscopic images of specimens compared to the prior art which involves fine manual positioning of points on the microplate to the image-shooting position.

What is claimed is:

1. An observation apparatus for capturing an image of a specimen stored in a plurality of specimen-disposing-sections in a container, said observation apparatus comprising:
(a) a holder for holding the container;
(b) an image-shooting unit for capturing an image of the specimen;
(c) a transfer unit for moving the container held with said holder relative to said image-shooting unit; and
(d) an observation point controller which positions each specimen-disposing-section in an image-shooting position of said image-shooting unit by controlling said transfer unit based on first coordinates of each specimen-disposing-section whose origin is a reference point defined for the container and relative coordinates of an observation point whose origin is said first coordinates.

2. The observation apparatus as defined in claim 1, wherein said observation point controller comprises:
an observation point coordinates calculator for calculating second coordinates of the observation point whose origin is the reference point, said second coordinates being calculated based on said first coordinates and said relative coordinates; and
a mechanism controller for controlling said transfer unit based on said second coordinates.

3. The observation apparatus as defined in claim 1 further comprising:
a display for displaying an image indicating a position in said container at the image-shooting position of said image-shooting unit; and
an input unit for inputting the observation point based on said image displayed.

4. An observation apparatus comprising:
(a) a container having a specimen-disposing-section for storing a specimen to be observed;
(b) an image-shooting unit for capturing an image of said specimen to be observed;
(c) a transfer unit for moving one of said container to said image-shooting unit, and said image-shooting unit to said container;
(d) a calculator for obtaining second coordinates whose origin is a reference point defined for said container by calculating first coordinates of said specimen-disposing-section whose origin is said reference point and relative coordinates of an observation point whose origin is said first coordinates; and
(e) a controller for controlling said transfer unit based on said second coordinates.

5. An observation method for capturing an image of a specimen stored in a plurality of specimen-disposing-sections in a container, said method comprising:
(a) holding the container with a holder;
(b) moving the container held with the holder relative to an image-shooting unit; and
(c) positioning each specimen-disposing-section in an image-shooting position of the image-shooting unit by controlling a transfer unit based on point coordinates of each specimen-disposing-section whose origin is a reference point defined for the container and relative coordinates of an observation point whose origin is said point coordinates.
